(19) United States
(12) Patent Application Publication
(10) Pub. No.: US 2026/0046624 A1
(43) Pub. Date: Feb. 12, 2026

(54) ROBUST ACCESS STRATUM SECURITY SETUP

(71) Applicant: QUALCOMM Incorporated, San Diego, CA (US)

(72) Inventors: Soo Bum LEE, San Diego, CA (US); Adrian Edward ESCOTT, Reading (GB); Hongil KIM, San Diego, CA (US)

(21) Appl. No.: 18/798,518

(22) Filed: Aug. 8, 2024

(51) Int. Cl. H04W 12/08; H04L 9/32

(52) U.S. Cl. CPC H04W 12/08; H04L 9/3236

(57) ABSTRACT

Systems and techniques are disclosed for securing wireless communications. For example, a process for securing access to a wireless network can include: recording a set of unprotected messages exchanged between a wireless device and a wireless node, wherein the set of unprotected messages include at least one of: portions of system information messages broadcast by the wireless node, portions of a set of RA messages, or portions of a set of radio resource control (RRC) messages; receiving a first hash value from the wireless node; generating a second hash value based on the recorded set of unprotected messages; and comparing the second hash value to the first hash value to verify the set of unprotected messages.

### FIELD

The present disclosure generally relates to wireless communications. For example, aspects of the present disclosure relate to a technique for a robust access stratum security setup.

### BACKGROUND

Wireless communications systems are deployed to provide various telecommunications and data services, including telephony, video, data, messaging, and broadcasts. Broadband wireless communications systems have developed through various generations, including a first-generation analog wireless phone service (1G), a second-generation (2G) digital wireless phone service (including interim 2.5G networks), a third-generation (3G) high speed data, Internet-capable wireless device, and a fourth-generation (4G) service (e.g., Long-Term Evolution (LTE), WiMax). Examples of wireless communications systems include code division multiple access (CDMA) systems, time division multiple access (TDMA) systems, frequency division multiple access (FDMA) systems, orthogonal frequency division multiple access (OFDMA) systems, Global System for Mobile communication (GSM) systems, etc. Other wireless communications technologies include 802.11 Wi-Fi, Bluetooth, among others.

A fifth-generation (5G) mobile standard calls for higher data transfer speeds, greater number of connections, and better coverage, among other improvements. The 5G standard (also referred to as “New Radio” or “NR”), according to Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. A sixth-generation (6G) mobile standard may build on 5G to offer further increased data transfer speeds, better coverage, and improved security, among other improvements.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Disclosed are systems, methods, apparatuses, and computer-readable media for performing wireless communications. In one illustrative example, a method securing access to a wireless network is provided. The method includes: recording a set of unprotected messages exchanged between a wireless device and a wireless node, wherein the set of unprotected messages include at least one of: portions of system information messages broadcast by the wireless node, portions of a set of RA messages, or portions of a set of radio resource control (RRC) messages; receiving a first hash value from the wireless node; generating a second hash value based on the recorded set of unprotected messages; and comparing the second hash value to the first hash value to verify the set of unprotected messages.

As another example, an apparatus for securing access to a wireless network is provided. The apparatus includes: a memory system comprising instructions; and a processor system coupled to the memory system, wherein the processor system is configured to: record a set of unprotected messages exchanged between the apparatus and a wireless node, wherein the set of unprotected messages include at least one of: portions of system information messages broadcast by the wireless node, portions of a set of RA messages, or portions of a set of radio resource control (RRC) messages; receive a first hash value from the wireless node; generate a second hash value based on the recorded set of unprotected messages; and compare the second hash value to the first hash value to verify the set of unprotected messages.

In another example, a non-transitory computer-readable medium having stored thereon instructions is provided. The instructions, when executed by at least one processor, cause the at least one processor to: record a set of unprotected messages exchanged between the apparatus and a wireless node, wherein the set of unprotected messages include at least one of: portions of system information messages broadcast by the wireless node, portions of a set of RA messages, or portions of a set of radio resource control (RRC) messages; receive a first hash value from the wireless node; generate a second hash value based on the recorded set of unprotected messages; and compare the second hash value to the first hash value to verify the set of unprotected messages.

For another example, an apparatus for securing access to a wireless network is provided. The apparatus includes: means for recording a set of unprotected messages exchanged between a wireless device and a wireless node, wherein the set of unprotected messages include at least one of: portions of system information messages broadcast by the wireless node, portions of a set of RA messages, or portions of a set of radio resource control (RRC) messages; means for receiving a first hash value from the wireless node; means for generating a second hash value based on the recorded set of unprotected messages; and means for comparing the second hash value to the first hash value to verify the set of unprotected messages.

As another example, a method for securing access to a wireless network is provided. The method includes: recording a set of unprotected messages exchanged between a wireless device and a wireless node for a random access (RA) procedure, wherein the set of unprotected messages include at least one of: portions of system information messages broadcast by the wireless node, portions of a set of RA messages, or portions of a set of radio resource control (RRC) messages; obtaining a first hash value based on the recorded set of unprotected messages; receiving a second hash value from a wireless device; comparing the second hash value to the first hash value to verify the set of unprotected messages; and communicating with the wireless device using access stratum (AS) security.

In another example, an apparatus for securing access to a wireless network is provided. The apparatus includes: a memory system comprising instructions; and a processor system coupled to the memory system, wherein the processor system is configured to: record a set of unprotected messages exchanged between a wireless device and the apparatus for a random access (RA) procedure, wherein the set of unprotected messages include at least one of: portions of system information messages broadcast by the apparatus, portions of a set of RA messages, or portions of a set of radio resource control (RRC) messages; obtain a first hash value based on the recorded set of unprotected messages; receive a second hash value from a wireless device; compare the second hash value to the first hash value to verify the set of unprotected messages; and communicate with the wireless device using access stratum (AS) security.

In another example, a non-transitory computer-readable medium having stored thereon instructions is provided. The instructions, when executed by at least one processor, cause the at least one processor to: record a set of unprotected messages exchanged between a wireless device and the apparatus for a random access (RA) procedure, wherein the set of unprotected messages include at least one of: portions of system information messages broadcast by the apparatus, portions of a set of RA messages, or portions of a set of radio resource control (RRC) messages; obtain a first hash value based on the recorded set of unprotected messages; receive a second hash value from a wireless device; compare the second hash value to the first hash value to verify the set of unprotected messages; and communicate with the wireless device using access stratum (AS) security.

As another example, an apparatus for securing access to a wireless network is provided. The method includes: means for recording a set of unprotected messages exchanged between a wireless device and a wireless node for a random access (RA) procedure, wherein the set of unprotected messages include at least one of: portions of system information messages broadcast by the wireless node, portions of a set of RA messages, or portions of a set of radio resource control (RRC) messages; means for obtaining a first hash value based on the recorded set of unprotected messages; receiving a second hash value from a wireless device; means for comparing the second hash value to the first hash value to verify the set of unprotected messages; and means for communicating with the wireless device using access stratum (AS) security.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

In some aspects, one or more of the apparatuses described herein comprises a mobile device (e.g., a mobile telephone or so-called “smart phone”, a tablet computer, or other type of mobile device), a wearable device, an extended reality device (e.g., a virtual reality (VR) device, an augmented reality (AR) device, or a mixed reality (MR) device), a personal computer, a laptop computer, a video server, a television (e.g., a network-connected television), a vehicle (or a computing device of a vehicle), or other device. In some aspects, the apparatus(es) includes at least one camera for capturing one or more images or video frames. For example, the apparatus(es) can include a camera (e.g., an RGB camera) or multiple cameras for capturing one or more images and/or one or more videos including video frames. In some aspects, the apparatus(es) includes at least one display for displaying one or more images, videos, notifications, or other displayable data. In some aspects, the apparatus(es) includes at least one transmitter configured to transmit one or more video frame and/or syntax data over a transmission medium to at least one device. In some aspects, the at least one processor includes a neural processing unit (NPU), a neural signal processor (NSP), a central processing unit (CPU), a graphics processing unit (GPU), any combination thereof, and/or other processing device or component.

Other objects and advantages associated with the aspects disclosed herein will be apparent to those skilled in the art based on the accompanying drawings and detailed description.

### BRIEF DESCRIPTION OF THE DRAWINGS

Examples of various implementations are described in detail below with reference to the following figures:

FIG. 1 is a block diagram illustrating an example of a wireless communication network, in accordance with some examples;

FIG. 2 is a diagram illustrating a design of a base station and a User Equipment (UE) device that enable transmission and processing of signals exchanged between the UE and the base station, in accordance with some examples;

FIG. 3 is a diagram illustrating an example of a disaggregated base station, in accordance with some examples;

FIG. 4 is a block diagram illustrating components of a user equipment, in accordance with some examples;

FIG. 5 illustrates an example connection procedure and AS security setup to establish a connection with a wireless network, in accordance with aspects of the present disclosure;

FIG. 6 illustrates example RA connection procedures for handover, RRC reestablishment and RRC resume, in accordance with aspects of the present disclosure;

FIG. 7 illustrates example RA connection procedure for a wireless communications system having a split architecture, in accordance with aspects of the present disclosure;

FIG. 8 is a flow diagram illustrating a process for securing access to a wireless system, in accordance with aspects of the present disclosure;

FIG. 9 is a flow diagram illustrating a process for securing access to a wireless system, in accordance with aspects of the present disclosure; and

FIG. 10 is a diagram illustrating an example of a system for implementing certain aspects of the present technology.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

Wireless networks are deployed to provide various communication services, such as voice, video, packet data, messaging, broadcast, and the like. A wireless network may support both access links for communication between wireless devices. An access link may refer to any communication link between a client device (e.g., a user equipment (UE), a station (STA), or other client device) and a base station (e.g., a 3^{rd} Generation Partnership Project (3GPP) gNodeB (gNB) for 5G/NR, a 3GPP eNodeB (eNB) for LTE, a Wi-Fi access point (AP), or other base station) or a component of a disaggregated base station (e.g., a central unit, a distributed unit, and/or a radio unit). In one example, an access link between a UE and a 3GPP gNB may be over a Uu interface. In some cases, an access link may support uplink signaling, downlink signaling, connection procedures, etc.

Various systems and techniques are provided with respect to wireless technologies (e.g., The 3GPP 5G/New Radio (NR) Standard, 6G, etc.) to provide improvements to wireless communications. A device (e.g., a UE, wireless device, mobile device, etc.) can be configured to access a wireless network (e.g., wireless system) to communicate with other devices. As a part of accessing the wireless network, the device may be configured to authenticate with the wireless network. Based on the authentication, the device may establish one or more security contexts to allow for private communications between the device and services of the wireless network. In some wireless networks, a wireless device connecting to the wireless network may establish a secure connection with a wireless access node of the wireless network using access stratum (AS) security. The wireless access node may be a network node, radio access network (RAN) node, wireless node, and the like, or any combination thereof. An AS layer may be a functional layer for a wireless network which acts between a wireless device and a wireless node that the wireless device is connected to, and the AS security may protect AS layer communications. Examples of AS layer communications may include radio resource control (RRC) messages, medium access control (MAC) messages, etc. Additional security layers may be applied in addition to the AS security.

AS security may be established as a part of or after a random access (RA) procedure. For example, AS security may be established after the RA procedure based on an AS security mode command procedure, or AS security may be established as a part of RA procedure during a handover procedure. The RA procedure may be used to connect a wireless device to a wireless node of the wireless network. The RA procedure may be performed based on a set of system information messages broadcast by the wireless node and the RA procedure may include a set of messages that may be exchanged. The system information messages may include information for accessing the wireless node and this information may be included in a master information block (MIB), a synchronization signal block (SSB), and/or one or more system information blocks (SIBs). The set of messages of the RA procedure that may be used to establish SA security may include message1 (msg1), message2 (msg2), message3 (msg3), and message4 (msg4). In some cases, an AS security mode command and an AS security mode complete message may be exchanged after msg4 to establish AS security. Messages transmitted prior to the AS security mode command (e.g., system information messages, msg1, msg2, msg3, and msg4) may be unprotected (e.g., transmitted in the clear, such as without encoding/encryption). In some cases, it may be useful to verify unprotected messages exchanged before AS security is established.

Systems, apparatuses, processes (also referred to as methods), and computer-readable media (collectively referred to as “systems and techniques”) are described herein for verifying unprotected messages exchanged before AS security is established to provide robust AS security. For example, portions of a set of unprotected messages exchanged between a wireless node and a wireless device may be recorded. For example, portions of the set of unprotected messages may be recorded by electronically codifying the set of unprotected messages so that the contents of the unprotected messages may be reproduced.

In some cases, the portions of the set of unprotected messages to be recorded may be configured. For example, the wireless device may receive an indication of the portions of system information messages broadcast by a wireless node and the portions of a set of RA messages for generating a hash value to record. The set of unprotected messages may include portions of the system information messages broadcast by the wireless node, along with a set of messages of the RA procedure (e.g., RA messages) that may be used to establish AS security. The RA messages may be messages exchanged between the wireless node and the wireless device as a part of the RA procedure. In some cases, the set of messages exchanged during the RA procedure may include a msg1 (e.g., RA preamble), msg2, and msg4. In some cases, msg3 may also be included in the set of messages of the RA procedure. The system information messages may include portions of the MIB/SSB/SIB(s). In some cases, information which is continuously changed over time, such as a system frame number, may be omitted from the portions of the system information messages.

The wireless device may generate a hash (e.g., digest) based on the recorded portions of the set of unprotected messages. The wireless device may transmit the hash to the wireless node, for example, as a part of an AS security mode complete command. The wireless node may also receive another hash from the wireless node, for example, in an AS security mode command. The other hash may be generated based on the set of unprotected messages (e.g., as recorded by the wireless node). The wireless device may compare the two hashes to verify the set of unprotected messages (e.g., the hashes are the same). The wireless device may then communicate with the wireless node using AS security.

Additional aspects of the present disclosure are described in more detail below.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smart-watch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs may communicate with a core network via a RAN, and through the core network the UEs may be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.) and so on.

A network entity may be implemented in an aggregated or monolithic base station architecture, or alternatively, in a disaggregated base station architecture, and may include one or more of a central unit (CU), a distributed unit (DU), a radio unit (RU), a transmission reception point (TRP), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a wireless node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs may send signals to a base station is called an uplink (UL) channel (e.g., a reverse traffic channel, a reverse control channel, an access channel, etc.). A communication link through which the base station may send signals to UEs is called a downlink (DL) or forward link channel (e.g., a paging channel, a control channel, a broadcast channel, or a forward traffic channel, etc.). The term traffic channel (TCH), as used herein, may refer to either an uplink, reverse or downlink, and/or a forward traffic channel.

The term “network entity” or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals (or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

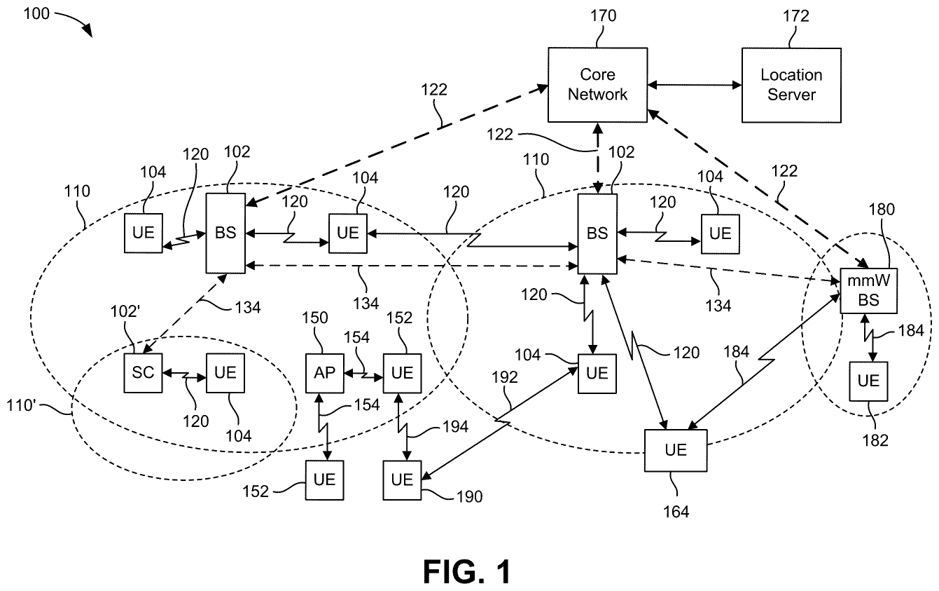

Various aspects of the systems and techniques described herein will be discussed below with respect to the figures. According to various aspects, FIG. 1 illustrates an example of a wireless communications system 100. The wireless communications system 100 (which may also be referred to as a wireless wide area network (WWAN)) may include various base stations 102 and various UEs 104. In some aspects, the base stations 102 may also be referred to as “network entities,” “wireless nodes,” or “network nodes.” One or more of the base stations 102 may be implemented in an aggregated or monolithic base station architecture. Additionally, or alternatively, one or more of the base stations 102 may be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 may include macro cell base stations (high power cellular base stations) and/or small cell base stations (low power cellular base stations). In an aspect, the macro cell base station may include eNBs and/or ng-eNBs where the wireless communications system 100 corresponds to a long term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of Ues. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency may be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the Ues 104 may include uplink (also referred to as reverse link) transmissions from a UE 104 to a base station 102 and/or downlink (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 may include devices (e.g., Ues, etc.) that communicate with one or more Ues 104, base stations 102, Aps 150, etc. utilizing the ultra-wideband (UWB) spectrum. The UWB spectrum may range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless nodes, network nodes, or entities (e.g., base stations 102/180, UEs 104/182) operate is divided into multiple frequency ranges, FR1 (from 450 to 6000 Megahertz (MHz)), FR2 (from 24250 to 52600 MHz), FR3 (above 52600 MHz), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency and/or component carrier over which some base station is communicating, the term “cell,” “serving cell,” “component carrier,” “carrier frequency,” and the like may be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (x component carriers) for transmission in each direction. The component carriers may or may not be adjacent to each other on the frequency spectrum. Allocation of carriers may be asymmetric with respect to the downlink and uplink (e.g., more or less carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In order to operate on multiple carrier frequencies, a base station 102 and/or a UE 104 may be equipped with multiple receivers and/or transmitters. For example, a UE 104 may have two receivers, “Receiver 1” and “Receiver 2,” where “Receiver 1” is a multi-band receiver that may be tuned to band (i.e., carrier frequency) ‘X’ or band ‘Y,’ and “Receiver 2” is a one-band receiver tuneable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (an SCell) in order to measure band ‘Y’ (and vice versa). In contrast, whether the UE 104 is being served in band ‘X’ or band ‘Y,’ because of the separate “Receiver 2,” the UE 104 may measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

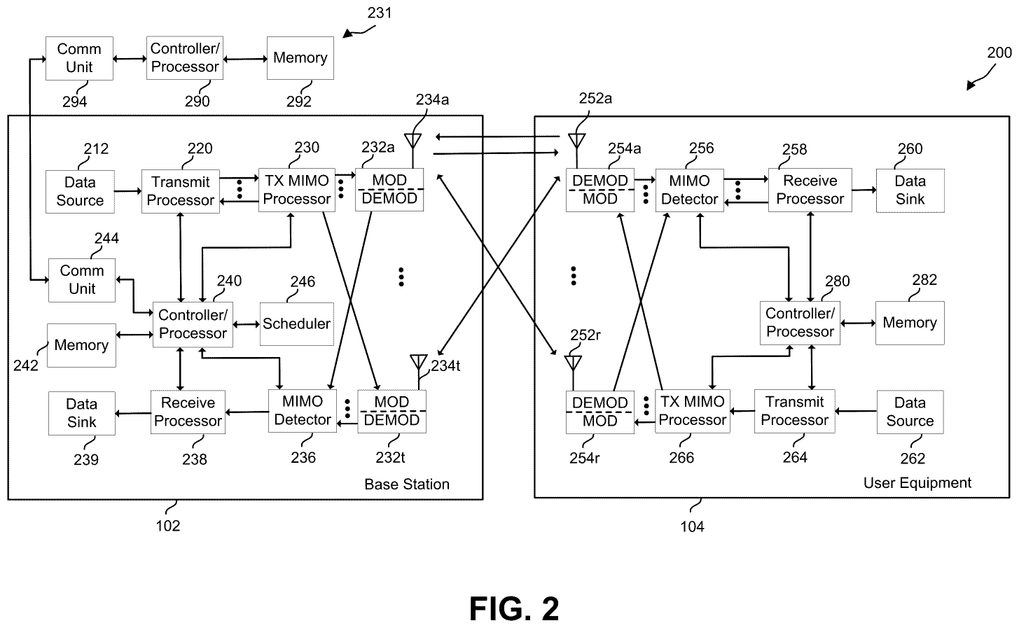

FIG. 2 shows a block diagram of a design of a base station 102 and a UE 104 that enable transmission and processing of signals exchanged between the UE and the base station, in accordance with some aspects of the present disclosure. Design 200 includes components of a base station 102 and a UE 104, which may be one of the base stations 102 and one of the UEs 104 in FIG. 1. Base station 102 may be equipped with T antennas 234a through 234t, and UE 104 may be equipped with R antennas 252a through 252r, where in general T≥1 and R≥1.

At base station 102, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, channel state information, channel state feedback, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. The modulators 232a through 232t are shown as a combined modulator-demodulator (MOD-DEMOD). In some cases, the modulators and demodulators may be separate components. Each modulator of the modulators 232a to 232t may process a respective output symbol stream, e.g., for an orthogonal frequency-division multiplexing (OFDM) scheme and/or the like, to obtain an output sample stream. Each modulator of the modulators 232a to 232t may further process (e.g., convert to analog, amplify, filter, and upconvert) the output sample stream to obtain a downlink signal. T downlink signals may be transmitted from modulators 232a to 232t via T antennas 234a through 234t, respectively. According to certain aspects described in more detail below, the synchronization signals may be generated with location encoding to convey additional information.

At UE 104, antennas 252a through 252r may receive the downlink signals from base station 102 and/or other base stations and may provide received signals to demodulators (DEMODs) 254a through 254r, respectively. The demodulators 254a through 254r are shown as a combined modulator-demodulator (MOD-DEMOD). In some cases, the modulators and demodulators may be separate components. Each demodulator of the demodulators 254a through 254r may condition (e.g., filter, amplify, downconvert, and digitize) a received signal to obtain input samples. Each demodulator of the demodulators 254a through 254r may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 104, a transmit processor 264 may receive and process data from a data source 262 and control information (e.g., for reports comprising RSRP, RSSI, RSRQ, CQI, channel state information, channel state feedback, and/or the like) from controller/processor 280. Transmit processor 264 may also generate reference symbols for one or more reference signals (e.g., based at least in part on a beta value or a set of beta values associated with the one or more reference signals). The symbols from transmit processor 264 may be precoded by a TX-MIMO processor 266 if application, further processed by modulators 254a through 254r (e.g., for DFT-s-OFDM, CP-OFDM, and/or the like), and transmitted to base station 102. At base station 102, the uplink signals from UE 104 and other UEs may be received by antennas 234a through 234t, processed by demodulators 232a through 232t, detected by a MIMO detector 236 if applicable, and further processed by a receive processor 238 to obtain decoded data and control information sent by UE 104. Receive processor 238 may provide the decoded data to a data sink 239 and the decoded control information to controller (processor) 240. Base station 102 may include communication unit 244 and communicate to a network controller 231 via communication unit 244. Network controller 231 may include communication unit 294, controller/processor 290, and memory 292.

In some aspects, one or more components of UE 104 may be included in a housing. Controller 240 of base station 102, controller/processor 280 of UE 104, and/or any other component(s) of FIG. 2 may perform one or more techniques associated with implicit uplink control information (UCI) beta value determination for NR.

Memories 242 and 282 may store data and program codes for the base station 102 and the UE 104, respectively. A scheduler 246 may schedule UEs for data transmission on the downlink, uplink, and/or sidelink.

In some aspects, deployment of communication systems, such as 5G new radio (NR) systems, may be arranged in multiple manners with various components or constituent parts. In a 5G NR system, or network, a network node, a network entity, a mobility element of a network, a radio access network (RAN) node, a wireless access node, a wireless node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also may be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which may enable flexibility in network design. The various units of the disaggregated base station, or disaggregated RAN architecture, may be configured for wired or wireless communication with at least one other unit.

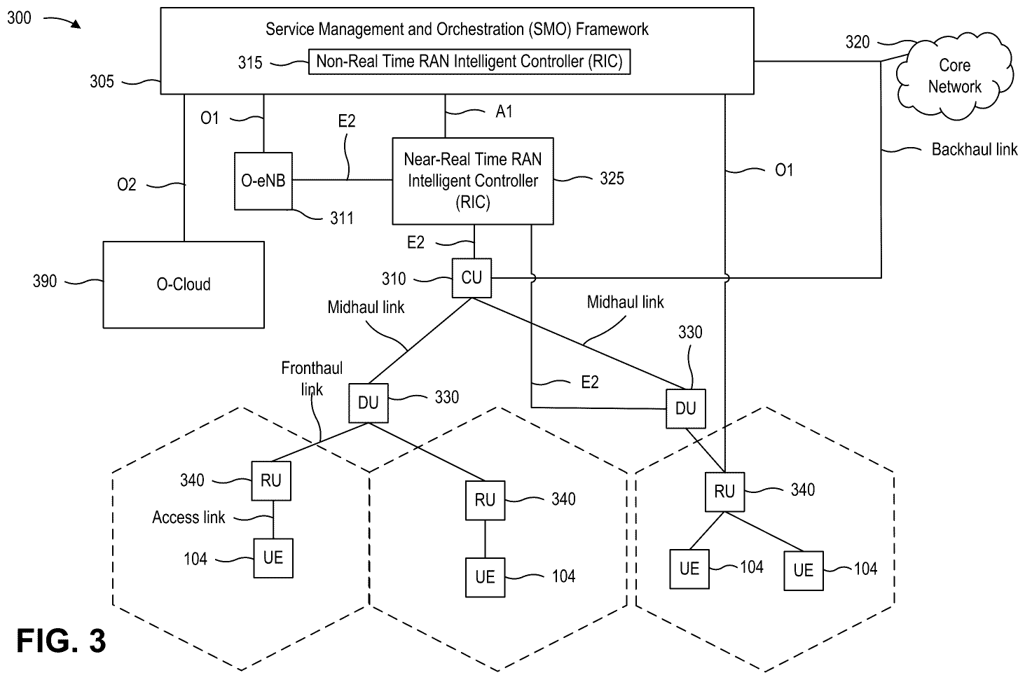

FIG. 3 shows a diagram illustrating an example disaggregated base station 300 architecture. The disaggregated base station 300 architecture may include one or more central units (CUs) 310 that may communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 104 via one or more radio frequency (RF) access links. In some implementations, the UE 104 may be simultaneously served by multiple RUs 340.

Each of the units, e.g., the CUs 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, may be configured to communicate with one or more of the other units via the transmission medium. For example, the units may include a wired interface configured to receive or transmit signals over a wired transmission medium to one or more of the other units. Additionally, the units may include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions may include radio resource control (RRC), packet data convergence protocol (PDCP), service data adaptation protocol (SDAP), or the like. Each control function may be implemented with an interface configured to communicate signals with other control functions hosted by the CU 310. The CU 310 may be configured to handle user plane functionality (i.e., Central Unit-User Plane (CU-UP)), control plane functionality (i.e., Central Unit - Control Plane (CU-CP)), or a combination thereof. In some implementations, the CU 310 may be logically split into one or more CU-UP units and one or more CU-CP units. The CU-UP unit may communicate bidirectionally with the CU-CP unit via an interface, such as the E1 interface when implemented in an O-RAN configuration. The CU 310 may be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) may be implemented with an interface configured to communicate signals with other layers (and modules) hosted by the DU 330, or with the control functions hosted by the CU 310.

Lower-layer functionality may be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 may be implemented to handle over the air (OTA) communication with one or more UEs 104. In some implementations, real-time and non-real-time aspects of control and user plane communication with the RU(s) 340 may be controlled by the corresponding DU 330. In some scenarios, this configuration may enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements may include, but are not limited to, CUs 310, DUs 330, RUs 340 and Near-RT RICs 325. In some implementations, the SMO Framework 305 may communicate with a hardware aspect of a 4G RAN, such as an open eNB (O-eNB) 311, via an O1 interface. Additionally, in some implementations, the SMO Framework 305 may communicate directly with one or more RUs 340 via an O1 interface. The SMO Framework 305 also may include a non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

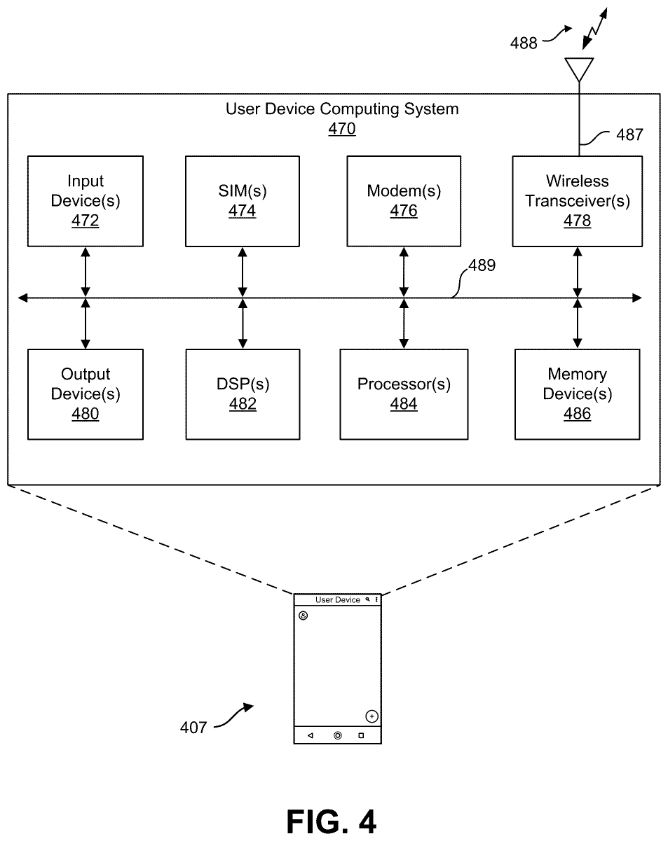

FIG. 4 illustrates an example of a computing system 470 of a wireless device 407. The wireless device 407 may include a client device such as a UE (e.g., UE 104, UE 152, UE 190) or other type of device (e.g., a station (STA) configured to communication using a Wi-Fi interface) that may be used by an end-user. For example, the wireless device 407 may include a mobile phone, router, tablet computer, laptop computer, tracking device, wearable device (e.g., a smart watch, glasses, an extended reality (XR) device such as a virtual reality (VR), augmented reality (AR) or mixed reality (MR) device, etc.), Internet of Things (IoT) device, access point, and/or another device that is configured to communicate over a wireless communications network. The computing system 470 includes software and hardware components that may be electrically or communicatively coupled via a bus 489 (or may otherwise be in communication, as appropriate). For example, the computing system 470 includes one or more processors 484. The one or more processors 484 may include one or more CPUs, ASICs, FPGAs, APs, GPUs, VPUs, NSPs, microcontrollers, dedicated hardware, any combination thereof, and/or other processing device or system. The bus 489 may be used by the one or more processors 484 to communicate between cores and/or with the one or more memory devices 486.

The computing system 470 may also include one or more memory devices 486, one or more digital signal processors (DSPs) 482, one or more subscriber identity modules (SIMs) 474, one or more modems 476, one or more wireless transceivers 478, one or more antennas 487, one or more input devices 472 (e.g., a camera, a mouse, a keyboard, a touch sensitive screen, a touch pad, a keypad, a microphone, and/or the like), and one or more output devices 480 (e.g., a display, a speaker, a printer, and/or the like).

In some aspects, computing system 470 may include one or more radio frequency (RF) interfaces configured to transmit and/or receive RF signals. In some examples, an RF interface may include components such as modem(s) 476, wireless transceiver(s) 478, and/or antennas 487. The one or more wireless transceivers 478 may transmit and receive wireless signals (e.g., signal 488) via antenna 487 from one or more other devices, such as other wireless devices, network devices (e.g., base stations such as eNBs and/or gNBs, Wi-Fi access points (APs) such as routers, range extenders or the like, etc.), cloud networks, and/or the like. In some examples, the computing system 470 may include multiple antennas or an antenna array that may facilitate simultaneous transmit and receive functionality. Antenna 487 may be an omnidirectional antenna such that radio frequency (RF) signals may be received from and transmitted in all directions. The wireless signal 488 may be transmitted via a wireless network. The wireless network may be any wireless network, such as a cellular or telecommunications network (e.g., 3G, 4G, 5G, etc.), wireless local area network (e.g., a Wi-Fi network), a Bluetooth™ network, and/or other network.

In some examples, the wireless signal 488 may be transmitted directly to other wireless devices using sidelink communications (e.g., using a PC5 interface, using a DSRC interface, etc.). Wireless transceivers 478 may be configured to transmit RF signals for performing sidelink communications via antenna 487 in accordance with one or more transmit power parameters that may be associated with one or more regulation modes. Wireless transceivers 478 may also be configured to receive sidelink communication signals having different signal parameters from other wireless devices.

In some examples, the one or more wireless transceivers 478 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end may generally handle selection and conversion of the wireless signals 488 into a baseband or intermediate frequency and may convert the RF signals to the digital domain.

In some cases, the computing system 470 may include a coding-decoding device (or CODEC) configured to encode and/or decode data transmitted and/or received using the one or more wireless transceivers 478. In some cases, the computing system 470 may include an encryption-decryption device or component configured to encrypt and/or decrypt data (e.g., according to the AES and/or DES standard) transmitted and/or received by the one or more wireless transceivers 478.

The one or more SIMs 474 may each securely store an international mobile subscriber identity (IMSI) number and related key assigned to the user of the wireless device 407. The IMSI and key may be used to identify and authenticate the subscriber when accessing a network provided by a network service provider or operator associated with the one or more SIMs 474. The one or more modems 476 may modulate one or more signals to encode information for transmission using the one or more wireless transceivers 478. The one or more modems 476 may also demodulate signals received by the one or more wireless transceivers 478 in order to decode the transmitted information. In some examples, the one or more modems 476 may include a Wi-Fi modem, a 4G (or LTE) modem, a 5G (or NR) modem, and/or other types of modems. The one or more modems 476 and the one or more wireless transceivers 478 may be used for communicating data for the one or more SIMs 474.

The computing system 470 may also include (and/or be in communication with) one or more non-transitory machine-readable storage media or storage devices (e.g., one or more memory devices 486), which may include, without limitation, local and/or network accessible storage, a disk drive, a drive array, an optical storage device, a solid-state storage device such as a RAM and/or a ROM, which may be programmable, flash-updateable and/or the like. Such storage devices may be configured to implement any appropriate data storage, including without limitation, various file systems, database structures, and/or the like.

In various embodiments, functions may be stored as one or more computer-program products (e.g., instructions or code) in memory device(s) 486 and executed by the one or more processor(s) 484 and/or the one or more DSPs 482. The computing system 470 may also include software elements (e.g., located within the one or more memory devices 486), including, for example, an operating system, device drivers, executable libraries, and/or other code, such as one or more application programs, which may comprise computer programs implementing the functions provided by various embodiments, and/or may be designed to implement methods and/or configure systems, as described herein.

In some previous wireless systems, multiple security contexts exist on layer basis and multiple services may exist with a single security context. For example, a security context, that is a result of an authentication procedure to establish cryptographically secured communication between two elements, may be established between a mobile device, such as a UE, and a core network (e.g., a non-access stratum (NAS) security context between a UE and an access and mobility management function (AMF)). This NAS security context may anchor other security contexts as other security contexts may build on the NAS security context. Another security context (e.g., access stratum (AS) security context) may also be established based on the NAS security context through the AMF. Additional application specific security context may then be established via the connection through the AS security context. In some cases, it may be useful to separate the security contexts from the NAS security context so that the additional security contexts above the NAS are not all dependent on the connection between the mobile device and the AMF. Additionally, having separate security contexts for services may streamline implementation of additional services without having to make sure the AMF supports any security features of the additional services.

In some cases, access stratum (AS) security may be used to secure a connection between a wireless device (e.g., UE) and a wireless node (e.g., eNodeB (eNB)/gNodeB (gNB), RU, etc.) of a wireless system that is connected to the wireless device. An AS may refer to a functional layer of the wireless system which includes the radio interface that connects the wireless device to the wireless system. The AS security may refer to a protocol at the AS layer that may be used to encrypt/decrypt messages between the wireless device and wireless system over the radio interface. In some cases, AS security may be applied in addition to other security that may be applied (e.g., at other protocol layers). In some cases, whether to apply AS security may be determined by services being accessed by the wireless device. For example, the wireless device may access a service which may, based on a service security policy, enable AS security as between the wireless device and the wireless node in lieu of user plane security. As another example, another service may, per another service security policy, enable both AS security and user plane security.

AS security may be established between the wireless device and the wireless node via an AS security mode command (SMC) process. In some cases, the AS SMC may be performed based on a cryptographic key (e.g., a string of random/pseudo random characters) associated with the wireless node and a selected cryptographic algorithm. To establish AS SMC, the wireless node may transmit a AS SMC and the UE may confirm establishment of AS security using an AS security mode complete message. After AS security is established, user plane (UP) or control plane (CP) messages, such as RRC messaging, may be secured via AS security. However, messages, such as RRC messages transmitted before AS security is established (e.g., before the AS SMC) may be transmitted in the clear without protection. While no serious attack on pre-AS security messages have been yet identified, it is possible that an attacker may be able to intercept, relay, and/or modify such messages resulting in potential man-in-the-middle attacks, authentication relays, privacy attacks based on traffic monitoring, service downgrade, denial of service attacks, selective pack drops, modified configuration/parameters, impersonation attacks, etc. In some cases, it may be useful for the wireless device or wireless node to be able to verify information obtained before AS security is established.

In some cases, to provide a robust AS security setup, it may be useful to verify the information obtained prior to establishing AS security. For example, messages exchanged prior to AS security establishment (e.g., before an AS SMC message) may be recorded and a digest (e.g., hash) of these messages may be determined. In some cases, the wireless device and the wireless node may both generate digests of messages exchanged prior to authentication. As a part of the AS SMC process, the wireless device and wireless node may exchange digests (or the digests may be exchanged after AS security is established). The wireless device may then compare the digest computed by the wireless device with a digest received from the wireless node. Similarly, the wireless node may compare the digest computed by the wireless node with a digest received from the wireless device. If the digests match, then the wireless device and wireless node may proceed with communications. If the digests are not the same, then the wireless device and wireless node may renegotiate (e.g., re-exchange) the pre-authentication parameters over secure messaging, such as RRC messages after AS security is established). The pre-authentication parameters may be the messages exchanges before the AS security establishment (e.g., RA messages, system information messages, RRC messages including system information (e.g., for hand-overs). In some cases, the wireless device and wireless node may determine whether to continue with the connection (e.g., if there are no other cells available, avoid potential denial of service or cell barring attacks, etc.) or release the connection and perform cell reselection.

In some cases, access stratum (AS) security may be used to secure a connection between the device and a wireless node of the wireless system that is connected to the device, such as a DU/CU/RU/TU/eNodeB/gNodeB/etc. An AS may refer to a functional layer of the wireless system which includes the radio interface that connects a device to the wireless system. The AS security may refer to a protocol at the AS layer that may be used to encrypt/decrypt messages between the device and wireless system over the radio interface. In some cases, AS security may be applied in addition to other security that may be applied (e.g., at other protocol layers). In some cases, whether to apply AS security may be determined by services being accessed by the device. For example, the device may access a service which may, based on a service security policy, enable AS security as between the device and the wireless node in lieu of user plane security. As another example, another service may, per another service security policy, enable both AS security and user plane security.

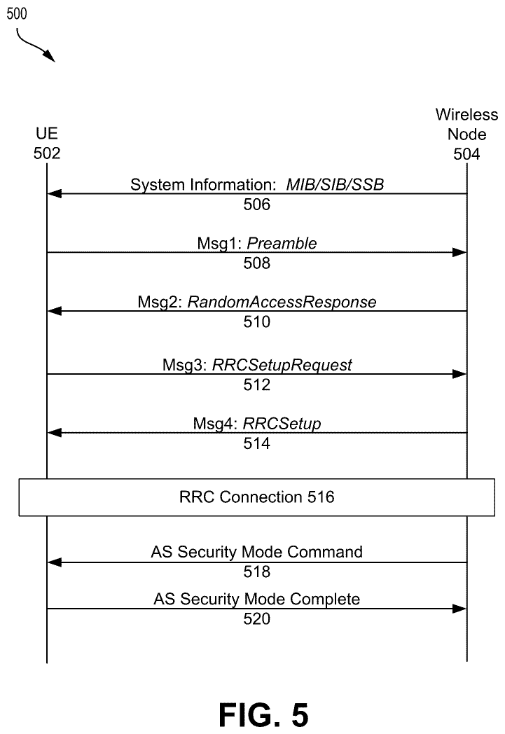

FIG. 5 illustrates an example connection procedure and AS security setup 500 to establish a connection with a wireless network, in accordance with aspects of the present disclosure. The connection procedure and AS security setup 500 may be performed between a UE 502 and wireless node 504 (e.g., BS/eNB/gNB, DU, etc.). The wireless node 504 may be any network entity that sets up or performs RRC signaling to the UE 502. In some cases, the wireless node 504 (e.g., wireless node, wireless access node) may broadcast system information messages 506. Examples of the system information messages 506 may include a master information block (MIB), synchronization signal block (SSB) (which may include the MIB), and a number of system information blocks (SIBs). In some cases, the UE 502 may receive one or more MIBs and use the MIBs to synchronize with the wireless node 504 and obtain parameters to decode the SIBs to camp on a cell associated with the wireless node 504. In some cases, the system information messages 506 may be specific to a particular cell.

After synchronizing with the wireless node 504 and decoding the system information, the UE 502 may connect to the cell by performing a random access (RA) procedure to connect to the wireless node 504. The RA procedure may include a set of RA messages that may be exchanged between the UE 502 and the wireless node 504. The set of RA messages may include (but are not limited to) msg1 508, msg2 510, msg3 512, and msg4 514. As shown in FIG. 5, the UE 502 may initiate the RA procedure by transmitting a msg1 508 to the wireless node 504. The msg1 508 may include an RA preamble from the UE 502 indicating a request access to the wireless node 504. In response to the msg1 508, the wireless node 504 may transmit a msg2 510 to the UE 502. Msg2 may be a MAC entity generated random access response message that may be transmitted in response to msg 1 508 by the wireless node 504. In some cases, the msg2 510 may include initial information for connecting to the wireless node, such as timing alignment information, an initial uplink grant, and identifiers. The identifiers may include a random access preamble identifier (RAPID), timing advance command (TAC), beam index, UL grant information, temporary cell radio network temporary identifier (TC-RNTI), etc. The msg2 510 may be transmitted in a media access control (MAC) protocol data unit (MAC PDU).

In response to the msg2 510, the UE 502 may transmit a msg3 512 to the wireless node 504. The msg3 512 may be an RRC connection request message. The msg3 512 may be transmitted based on the initial UL grant information from msg2 510 and the msg3 512 may include a RRC setup request. The RRC setup request may be a request to set up an RRC connection. For example, msg3 512 may include an RRCSetupRequest message. In response to the msg3 512, the wireless node 504 may transmit a msg4 514 to the UE 502. The msg4 514 may include, for example, a contention resolution identifier, ACK, RRC connection setup information, etc. MSG 4 may be transmitted via a MAC control element (MAC CE). The UE 502 may decode msg4 514 and then transmit a HARQ ACK to msg4 514 to finish the RA procedure. After the msg4 514 and ACK, the RRC connection 516 setup may be complete (e.g., there is an RRC connection between the UE 502 and the wireless node 504).

The wireless node 504 may then transmit an AS security mode command 518 to the UE 502 to establish AS security between the wireless node 504 and the UE 502. In some cases, the wireless node 504 may select an algorithm, such as an encryption algorithm, to use to protect CP and UP messages between the wireless node 504 and the UE 502 and the wireless node 504 may indicate the selected algorithm in the AS security mode command 518. The AS security mode command 518 may also be secured (encrypted) using the selected algorithm and a shared key between the wireless node 504 and the UE 502 and may not be tampered with by an adversary. The UE 502 may decode the AS security mode command using the indicated algorithm to establish secure CP communications (e.g., a secure RRC connection) and UP communications. In response to the AS security mode command 518, the UE 502 may transmit an AS security mode complete 520 message to the wireless node 504 to indicate that AS security has been established between the wireless node 504 and the UE 502. In some cases, the AS security mode command 518 and AS security mode complete 520 message may be considered a secure communication. In some cases, once AS security has been established between the wireless node 504 and the UE 502, what an attacker may be able to do with respect to UP messages, such as RRC messages, may be very limited.

As indicated above, messages transmitted prior to the AS security mode command 518 (e.g., system information messages 506, msg1 508, msg2 510, msg3 512, and msg4 514) may be unprotected. To provide protection for these unprotected messages, the unprotected messages may be verified as a part of establishing AS security. In some cases, hashes of portions of the unprotected messages may be verified. For example, the wireless node 504 may record portions of the unprotected messages and generate a hash (e.g., first hash) based on the recorded portions. To record unprotected messages received by the wireless node 504, the wireless node 504 may receive the unprotected messages and store the contents of the received unprotected messages in a memory. To record unprotected messages transmitted by the wireless node 504, the wireless node 504 may store the contents of the unprotected messages to be transmitted in the memory. The first hash generated by the wireless node 504 may be included in the AS security mode command 518 sent to the UE 502.

In some cases, the wireless node 504 may record and generate the first hash based on portions of the system information messages 506 broadcasted (e.g., SSB/MIB/SIB1, etc.), msg1 508, msg2 510, and msg4 514. In some cases, a system frame number (SFN) in the MIB may not be included in the first hash as the SFN may be continuously changed (e.g., time varying). Other continuously changed information may also be excluded from the hash generation. In some cases, the UE 502 may attempt to connect to the wireless node 504 before receiving additional SIBs (e.g., SIB2-SIB21), and the first hash may be generated based on information (e.g., parameters) from SIB1 (e.g., not generated based on information in the additional SIBs) (for NR/5G or SIB1/SIB2 for LTE). In some cases, information from the SIB1 that may be included in the first hash may be (e.g., the first hash may be generated based on) information that may be used for cell access (e.g., cell identification information). Information that may be used for cell access can include a PRACH Configuration (prach-Configindex), set of available random access preambles, RA response window size (ra-ResponseWindowSize), initial preamble power (preambleInitialRecievedTargetPower), power ramping factor (powerRampingStep), maximum number of preamble transmission (preambleTransMax), and contention resolution timer (mac-ContentionResolutionTimer). In some cases, other information from SIB1 may be exchanged/verified after AS security setup. In some cases, the first hash may be generated based on an entirety of SIB1.

In some cases, the TC-RNTI in msg2 510 may not be included in the first hash when contention free RACH (CFRA) is used as the TC-RNTI may be ignored in CFRA. In some cases, the TC-RNTI becomes the C-RNTI after contention resolution after msg2 510. In cases where a cell radio network temporary identifier (C-RNTI) is provided to the UE 502 and wireless node 504 prior to the RA procedure (e.g., cell reconnection), the C-RNTI value may be included in the first hash. In some cases, a resource location of the physical downlink control channel (PDCCH) may be provided in msg2 510 and the value of the resource location of the PDCCH may be included in the first hash.

In some cases, msg3 512 may not be included in (e.g., used to generate) the first hash as msg3 512 may just include the RRC connection request without other information and may not be vulnerable to attack for the UE 502 and wireless node 504. In other cases, the wireless node 504 may generate the first hash based on portions of all of the unprotected messages (e.g., generating the first hash based on all of SIB1 and msg3 512 information). In some cases, portions (e.g., parameters, information, etc.) covered by the first hash may be indicated in the AS security mode command 518 or via the system information messages 506 (e.g., via SIB1) received by the UE 502.

In some cases, the UE 502 may also record portions of the unprotected messages and generate another hash (e.g., second hash) based on the recorded portions of the unprotected messages. In some cases, the UE 502 may be preconfigured (e.g., via a standard, provisioned as a part of configuration, etc.) with the portions of the unprotected messages to record and use to generate the second hash. In other cases, the UE 502 may determine which portions of the unprotected messages to record and/or use to generate the second hash based on an indication received from the wireless node 504 (e.g., via the AS security mode command 518 or via the system information messages 506 (e.g., SIB1)). In some cases, the UE 502 may record all of the unprotected messages and then generate the second hash based on portions of the unprotected messages. The portions of the unprotected messages recorded by the UE 502 and/or used to generate the second hash may be same portions of the unprotected messages as described above with respect to the wireless node 504. The UE 502 may transmit the generated second hash to the wireless node 504 in the AS security mode complete 520 message. In some cases, the UE 502 may verify the first hash (e.g., received in the AS security mode command 518) against the second hash and then transmit the second hash in the AS security mode complete 520 message. In some cases, hash verification may be performed either at the UE 502 or at the wireless node 504 but not both.

After receiving the AS security mode complete 520 message, the wireless node 504 may verify the second hash against the first hash. If the hashes are the same, then the wireless node 504 may proceed with communicating with the UE 502. In some cases, if the hashes do not match, the wireless node 504 may indicate to the UE 502 that there was a verification failure (e.g., failure to verify the unprotected messages) and request the information transmitted by the UE 502 (e.g., msg1 508, msg3 512, if covered by the hash). The UE 502 may then transmit information received from the wireless node 504 (e.g., including information from a potential attacker) to the wireless node 504 using secured RRC messaging (e.g., secured by AS security). In some cases, the UE 502 may transmit the recorded portions of the unprotected messages to the wireless node 504. The wireless node 504 may compare the information received from the UE 502 to the corresponding information sent by/received by the wireless node 504 to identify any differing information. The wireless node 504 may then retransmit/request the UE 502 retransmit differing information via secure RRC messaging.

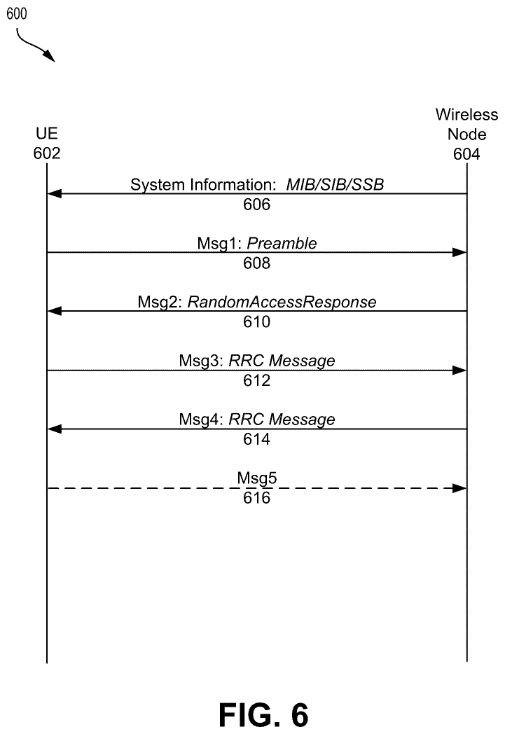

FIG. 6 illustrates example RA connection procedures 600 for handover, RRC reestablishment and RRC resume, in accordance with aspects of the present disclosure. In an RRC reconfiguration case (e.g., handover) where a UE 602 hands over a target wireless node 604 (e.g., wireless node, wireless access node), the UE 602 may not need to read system information 606 messages broadcast by the wireless node 604 as the UE 602 may receive the information from the system information from a handover wireless node. The UE 602 may transmit a msg1 608 and receive a msg2 610 in a manner substantially similar to that described above with respect to FIG. 5. In the RRC reconfiguration case, the msg3 may include an RRC connection complete message, which may be a protected message, as the UE 602 may be able to exchange secure messages without performing the AS security mode command exchange (e.g., AS security mode command 518 and AS security mode complete 520 messages of FIG. 5). In such cases, the msg3 may include a first hash generated based on msg1 608 and msg2 610. The first hash may be generated in a manner similar to that described above with respect to FIG. 5 for the respective messages (e.g., msg1 508 and msg2 510 of FIG. 5). In some cases, the handover is complete after msg3 612.

In some cases, the system information 606 (e.g., information from MIB/SIB1) may not be included in the first hash in the handover case as the system information 606 may be obtained from a handover wireless node. For example, the UE 602 may be connected to the handover wireless node and the handover wireless node may be performing a handover operation of the UE 602 to the wireless node 604. The handover wireless node may obtain the system information from the wireless node 604 and provide this system information to the UE 602, for example, in an RRC reconfiguration message, as a part of handing over the UE 602. In some cases, the handover wireless node may also receive a hash of the system information from the wireless node 604 or the handover wireless node may generate the hash of the system information. The handover wireless node may provide the hash of the system information of the wireless node 604 to the UE 602, for example, in the RRC reconfiguration message. In other cases, the hash of the system information may be exchanged in a dedicated RRC message exchange after completion of the handover, such as in msg4 614 as a downlink RRC message and/or msg5 616 as an uplink RRC message.

In the RRC reestablishment case, the UE 602 may have had a broken radio link with the wireless node 604 and may be reestablishing a connection with the wireless node 604. In some cases, the RRC reestablishment case may be similar to the RRC reconfiguration case as the UE 602 has already obtained the system information 606 messages from the wireless node 604 and may not need to reobtain the system information. The UE 602 may transmit msg1 608 and receive msg2 610 in a manner similar to that described above with respect to RRC reconfiguration and FIG. 5. The UE 602 may then transmit a RRC reestablishment message in msg3 612. In some case, the msg3 612 may include a first hash of all of the prior messages, including the RRC reestablishment message and msg3 612. In some cases, the portions of the msg1 608 and msg2 610 included in the first hash may be similar to that described above with respect to FIG. 5 for the respective messages (e.g., msg1 508 and msg2 510 of FIG. 5). The wireless node 604 may responds with a RRC reestablishment complete message in msg4 614. In some cases, msg4 614 may include a second hash of all of the previous messages, including msg3 612. In some cases, the RRC resume case may be substantially similar to the RRC reestablishment case with respect to generating and transmitting the first hash and second hash.

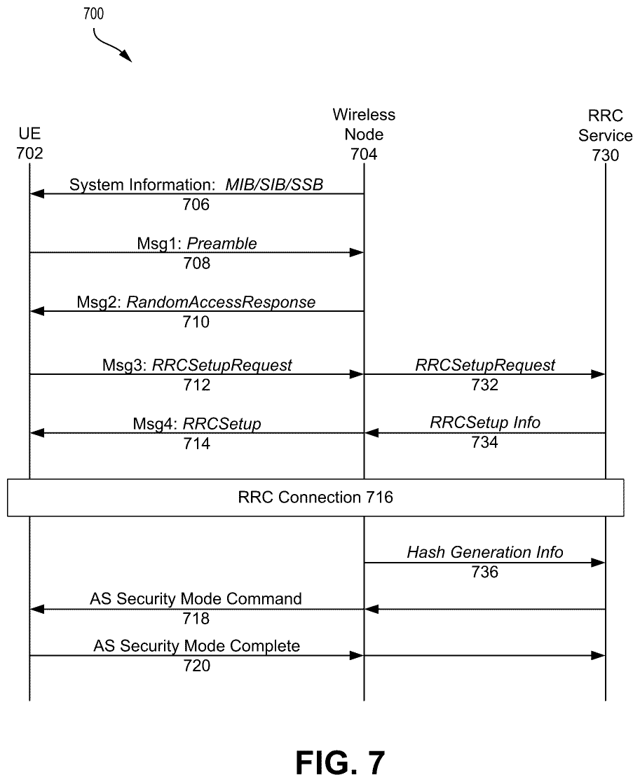

FIG. 7 illustrates example RA connection procedure 700 for a wireless communications system having a split architecture, in accordance with aspects of the present disclosure. In a split architecture, RRC may be implemented as a service (e.g., RRC service 730) and this RRC service/layer is logically separate from other services/layers provided by a wireless node 704 (e.g., eNB/gNB or DU for a disaggregated base station). The wireless node may host the MAC layer and other lower level layers separately from the RRC service/layer. The RRC service/layer may be collocated at the wireless node or the RRC service 730 may be a separate service hosted, for example, at a CU, in the cloud in a 6G service-based architecture, CU-CP architecture in 5G, etc. In some cases, functionality of the RRC layer may be split between the base station and a separate RRC service.

In a split architecture, the wireless node 704 may broadcast system information messages 706 in a manner substantially similar to that described above with respect to system information messages 506 of FIG. 5. Similarly, a UE 702 may decode the system information messages 706 and transmit a msg1 708 to the wireless node 704 in a manner substantially similar to that described above with respect to msg1 508 of FIG. 5. The wireless node 704 may transmit a msg2 710 to the UE 702 in response to the msg1 708 in a manner substantially similar to that described above with respect to a msg2 510 of FIG. 5. In response to the msg2 710, the UE 702 may transmit a msg3 712 to the wireless node 704. The msg3 712 may be an RRC connection request message and may be substantially similar to msg3 512 of FIG. 5. The wireless node 704 may forward the RRC connection request message 732 to the RRC service 730. The RRC service 730 may transmit RRC connection setup information 734 to the wireless node 704 in response to the RRC connection request message 732 to establish an RRC connection to the UE 702. The wireless node 704 may then transmit a msg4 714 to the UE 702. The msg 4 714 may include the RRC connection setup information from the RRC service 730 to establish an RRC connection 716 between the UE 702 and the RRC service 730 via the wireless node 704.

The wireless node 704 may also transmit information for generating the first hash 736 to the RRC service 730. As discussed above, the information for generating the first hash may include portions of the unprotected messages. The portions of the unprotected messages that may be included for generating the first hash may be substantially similar to those portions discussed above with respect to FIG. 5. In some cases, the information for generating the first hash 736 may include information transmitted to the UE 702 by the wireless node 704 and not available directly to the RRC service 730. For example, in addition to msg1 708 and msg2 710, msg4 714 may include RRC information (e.g., received by the wireless node 704 from the RRC service 730) as well as information carried over MAC CE, which the RRC service 730 may not have access to. The information for generating the first hash 736 may include portions of the RA messages (e.g., msg1 708, msg2 710, and portions of msg4 714). In some cases, the wireless node 704 may transmit the information for generating the first hash 736 to the RRC service 730 via a secure interface, such as a backhaul network using transport layer security, F1 interface, etc.

The RRC service 730 may receive the information for generating the first hash 736 and the RRC service 730 may generate the first hash in a manner substantially similar to that described above with respect to FIG. 5. For example, the RRC service 730 may generate the first hash based on the information for generating the first hash 736 and any unprotected RRC messages that may be exchanged as a part of establishing the RRC connection 716. The RRC service 730 may then transmit the first hash to the wireless node 704 in an AS security mode command 718 and the wireless node 704 may forward the AS security mode command 718 including the first hash to the UE 702. The UE 702 may verify the first hash in a manner substantially similar to that discussed above with respect to FIG. 5. The UE 702 may generate the second hash in a manner substantially similar to that described above with respect to FIG. 5. The UE 702 may include the second hash in the AS security mode complete message 720 transmitted to the wireless node 704 in a manner substantially similar to that described above with respect to FIG. 5. The wireless node 704 may forward the AS security mode complete message 720 including the second hash to the RRC service 730 and the RRC service 730 may verify the second hash in a manner substantially similar to that described above with respect to FIG. 5.

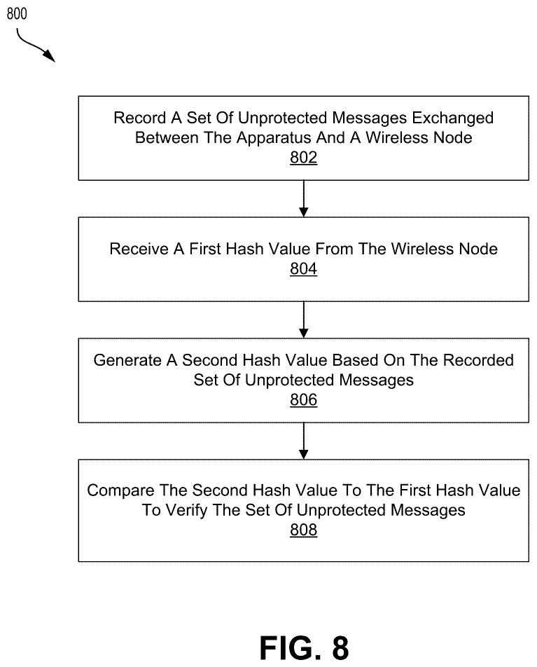

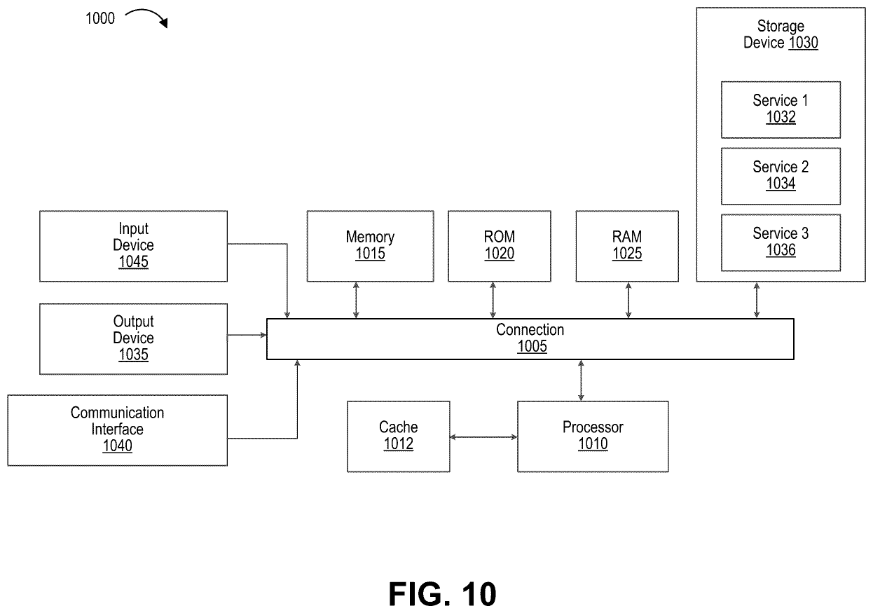

FIG. 8 is a flow diagram illustrating a process 800 for securing access to a wireless system, in accordance with aspects of the present disclosure. The process 800 can be performed by a wireless device capable of connecting to a wireless node of a wireless network (e.g., BS 102, mmW BS 180, DU 330 of FIG. 3, CU 310 of FIG. 3, network node 504 of FIG. 5, network node 604 of FIG. 6, wireless node 704 of FIG. 7, RRC service 730 of FIG. 7, computing system 1000 of FIG. 10, etc.). The wireless device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device (e.g., UE 104, of FIGS. 1 and 2, respectively, wireless device 407 of FIG. 4, UE 502 of FIG. 5, UE 602 of FIG. 6, UE 702 of FIG. 7, and computing system 1000 of FIG. 10, etc.). The operations of the process 800 may be implemented as software components that are executed and run on one or more processors (e.g., processor 1010 of FIG. 10 or other processor(s)). Further, the transmission and reception of signals by the wireless network (or component of the wireless network, such as the security service) in the process 800 may be enabled, for example, by one or more antennas (e.g., antennas 252 of FIG. 2) and/or one or more transceivers (e.g., modulators/demodulators 254, TX MIMO processor 266, MIMO detector 256, transmit processor 264, receive processor 258 of FIG. 2, etc.).

At block 802, the computing device (or component thereof) may record a set of unprotected messages exchanged between the apparatus and a wireless node. The set of unprotected messages include at least one of: portions of system information messages broadcast by the wireless node (e.g., system information 506, system information 606, system information 706, etc.) portions of a set of RA messages, or portions of a set of radio resource control (RRC) messages. In some cases, portions of the set of unprotected messages may be recorded by electronically codifying the set of unprotected messages so that the contents of the unprotected messages may be reproduced. In some examples, the set of RA messages includes at least a message2 message and a message4 message received by the apparatus and a RA preamble transmitted by the apparatus. In some cases, the set of RA messages further includes a includes message3 message transmitted by the apparatus. In some examples, the system information messages includes at least one of a master information block (MIB), synchronization signal block (SSB), or one or more system information blocks (SIBs). In some cases, the portions of system information messages include an entirety of the MIB, SSB, or the one or more SIBs, except for information in MIB, SSB, or the one or more SIBs that are continuously changed over time. For example, a system frame number (SFN) in the MIB may not be included in the first hash as the SFN may be continuously changed (e.g., time varying). In some examples, the computing device (or component thereof) may receive an indication of the portions of system information messages broadcast by a wireless node and the portions of a set of RA messages for generating the second hash value to record. In some cases, the portions of system information messages include at least one of a: physical random access channel configuration; available set of random access preambles; RA response window size; initial preamble power; power ramping factor; maximum number of preamble transmissions; or contention resolution timer. In some examples, the portions of system information messages further includes at least one of a: location of a physical downlink control channel (PDCCH); or cell radio network temporary identifier (C-RNTI).

At block 804, the computing device (or component thereof) may receive a first hash value from the wireless node. In some cases, the first hash value is received as a part of an access stratum (AS) security mode command message. For example, a hash may be transmitted by a wireless node in an AS security mode command (e.g., AS security mode command 518 of FIG. 5) to a UE.

At block 806, the computing device (or component thereof) may generate a second hash value based on the recorded set of unprotected messages. In some cases, the computing device (or component thereof) may transmit the second hash value to the wireless node to establish access stratum (AS) security between the wireless node and the apparatus. In some examples, the second hash value is transmitted as a part of an AS security mode complete message. For example, a UE (e.g., UE 502 of FIG. 5) may transmit a generated hash to a wireless node (e.g., wireless node 504 of FIG. 5) in an AS security mode complete (e.g., AS security mode complete 520 of FIG. 5) message.

At block 808, the computing device (or component thereof) may compare the second hash value to the first hash value to verify the set of unprotected messages. In some cases, the apparatus verifies the set of unprotected messages and the wireless node does not verify the set of unprotected messages. In some examples, the computing device (or component thereof) may determine that the first hash value does not match the second hash value; receive a request for the set of unprotected messages indicating a verification failure for the set of unprotected messages; and transmit the set of unprotected messages to the wireless node using AS security.

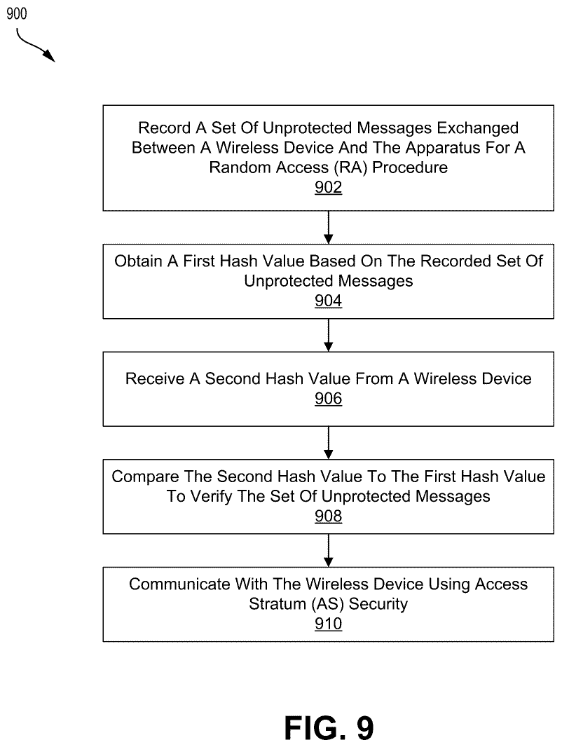

FIG. 9 is a flow diagram illustrating a process 900 for securing access to a wireless system, in accordance with aspects of the present disclosure. The process 900 can be performed by a component or system (e.g., a chipset, server, device, etc.) of a wireless network (e.g., BS 102, mmW BS 180, network node 504 of FIG. 5, network node 604 of FIG. 6, wireless node 704 of FIG. 7, RRC service 730 of FIG. 7, computing system 1000 of FIG. 10, etc.). The wireless device may be a mobile device (e.g., UE 104, of FIGS. 1 and 2, respectively, wireless device 407 of FIG. 4, UE 502 of FIG. 5, UE 602 of FIG. 6, UE 702 of FIG. 7, and computing system 1000 of FIG. 10, etc.), a network-connected wearable such as a watch, an extended reality (XR) device such as a virtual reality (VR) device or augmented reality (AR) device, a vehicle or component or system of a vehicle, or other type of computing device. The operations of the process 900 may be implemented as software components that are executed and run on one or more processors (e.g., processor 1010 of FIG. 10 or other processor(s)). Further, the transmission and reception of signals by the wireless network (or component of the wireless network, such as the security service) in the process 900 may be enabled, for example, by one or more antennas (e.g., antennas 234 of FIG. 2) and/or one or more transceivers (e.g., modulators/demodulators 232, TX MIMO processor 230, MIMO detector 236, transmit processor 220, receive processor 238 of FIG. 2, etc.).

At block 902, the computing device (or component thereof) may record a set of unprotected messages exchanged between a wireless device and the apparatus for a random access (RA) procedure. The set of unprotected messages include at least one of: portions of system information messages broadcast by the apparatus, portions of a set of RA messages, or portions of a set of radio resource control (RRC) messages. In some cases, portions of the set of unprotected messages may be recorded by electronically codifying the set of unprotected messages so that the contents of the unprotected messages may be reproduced. In some examples, the set of RA messages includes at least a message2 message and a message4 message transmitted to the wireless device and a RA preamble received from the wireless device. In some cases, the set of RA messages further includes a includes message3 message received from the wireless device. In some examples, the system information messages include at least one of a master information block (MIB), synchronization signal block (SSB), or one or more system information blocks (SIBs). In some cases, the portions of system information messages include an entirety of the MIB, SSB, or the one or more SIBs, except for information in MIB, SSB, or the one or more SIBs that are continuously changed over time. For example, a system frame number (SFN) in the MIB may not be included in the first hash as the SFN may be continuously changed (e.g., time varying). In some examples, the computing device (or component thereof) may output, for transmission to the wireless device, an indication of the portions of system information messages broadcast and the portions of a set of RA messages for generating the second hash value. In some cases, the portions of system information messages include at least one of a: physical random access channel configuration; available set of random access preambles; RA response window size; initial preamble power; power ramping factor; maximum number of preamble transmissions; or contention resolution timer. In some examples, the portions of system information messages further includes at least one of a: location of a physical downlink control channel (PDCCH); or cell radio network temporary identifier (C-RNTI).

At block 904, the computing device (or component thereof) may obtain a first hash value based on the recorded set of unprotected messages. In some cases, the computing device (or computing thereof) may output, for transmission to the wireless device, the first hash value. For example, a hash may be transmitted by a wireless node in an AS security mode command (e.g., AS security mode command 518 of FIG. 5) to a UE. In some examples, the first hash value is output for transmission as a part of an access stratum (AS) security mode command message.

At block 906, the computing device (or component thereof) may receive a second hash value from a wireless device. In some cases, the second hash value is received as a part of an AS security mode complete message. In some examples, the computing device (or component thereof) may transmit the set of unprotected messages to an RRC service; and receive the first hash value from the RRC service.

At block 908, the computing device (or component thereof) may compare the second hash value to the first hash value to verify the set of unprotected messages. In some cases, the apparatus verifies the set of unprotected messages and the wireless device does not verify the set of unprotected messages. In some cases, the computing device (or component thereof), may determine that the second hash value does not match the first hash value; and output, for transmission, a request for the set of unprotected messages indicating a verification failure for the set of unprotected messages.

At block 910, the computing device (or component thereof) may communicate with the wireless device using access stratum (AS) security.

In some examples, the techniques or processes described herein may be performed by a computing device, an apparatus, and/or any other computing device. In some cases, the computing device or apparatus may include a processor, microprocessor, microcomputer, or other component of a device that is configured to carry out the steps of processes described herein. In some examples, the computing device or apparatus may include a camera configured to capture video data (e.g., a video sequence) including video frames. For example, the computing device may include a camera device, which may or may not include a video codec. As another example, the computing device may include a mobile device with a camera (e.g., a camera device such as a digital camera, an IP camera or the like, a mobile phone or tablet including a camera, or other type of device with a camera). In some cases, the computing device may include a display for displaying images. In some examples, a camera or other capture device that captures the video data is separate from the computing device, in which case the computing device receives the captured video data. The computing device may further include a network interface, transceiver, and/or transmitter configured to communicate the video data. The network interface, transceiver, and/or transmitter may be configured to communicate Internet Protocol (IP) based data or other network data.

The processes described herein can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

In some cases, the devices or apparatuses configured to perform the operations of the processes 800, 900, and/or other processes described herein may include a processor, microprocessor, micro-computer, or other component of a device that is configured to carry out the steps of the processes 800, 900, and/or other process. In some examples, such devices or apparatuses may include one or more sensors configured to capture image data and/or other sensor measurements. In some examples, such computing device or apparatus may include one or more sensors and/or a camera configured to capture one or more images or videos. In some cases, such device or apparatus may include a display for displaying images. In some examples, the one or more sensors and/or camera are separate from the device or apparatus, in which case the device or apparatus receives the sensed data. Such device or apparatus may further include a network interface configured to communicate data.

The components of the device or apparatus configured to carry out one or more operations of the processes 800, 900, and/or other processes described herein can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The processes 800 and 900 are illustrated as a logical flow diagram, the operations of which represent sequences of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein (e.g., the processes 800, 900, and/or other processes) may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 10 is a diagram illustrating an example of a system for implementing certain aspects of the present technology. In particular, FIG. 10 illustrates an example of computing system 1000, which may be for example any computing device making up internal computing system, a remote computing system, a camera, or any component thereof in which the components of the system are in communication with each other using connection 1005. Connection 1005 may be a physical connection using a bus, or a direct connection into processor 1010, such as in a chipset architecture. Connection 1005 may also be a virtual connection, networked connection, or logical connection.

In some embodiments, computing system 1000 is a distributed system in which the functions described in this disclosure may be distributed within a datacenter, multiple data centers, a peer network, etc. In some embodiments, one or more of the described system components represents many such components each performing some or all of the function for which the component is described. In some embodiments, the components may be physical or virtual devices.

Example system 1000 includes at least one processing unit (CPU or processor) 1010 and connection 1005 that communicatively couples various system components including system memory 1015, such as read-only memory (ROM) 1020 and random access memory (RAM) 1025 to processor 1010. Computing system 1000 may include a cache 1012 of high-speed memory connected directly with, in close proximity to, or integrated as part of processor 1010.

Processor 1010 may include any general purpose processor and a hardware service or software service, such as services 1032, 1034, and 1036 stored in storage device 1030, configured to control processor 1010 as well as a special-purpose processor where software instructions are incorporated into the actual processor design. Processor 1010 may essentially be a completely self-contained computing system, containing multiple cores or processors, a bus, memory controller, cache, etc. A multi-core processor may be symmetric or asymmetric.

To enable user interaction, computing system 1000 includes an input device 1045, which may represent any number of input mechanisms, such as a microphone for speech, a touch-sensitive screen for gesture or graphical input, keyboard, mouse, motion input, speech, etc. Computing system 1000 may also include output device 1035, which may be one or more of a number of output mechanisms. In some instances, multimodal systems may enable a user to provide multiple types of input/output to communicate with computing system 1000.

Computing system 1000 may include communications interface 1040, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1040 may also include one or more Global Navigation Satellite System (GNSS) receivers or transceivers that are used to determine a location of the computing system 1000 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1030 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1030 may include software services, servers, services, etc., that when the code that defines such software is executed by the processor 1010, it causes the system to perform a function. In some embodiments, a hardware service that performs a particular function may include the software component stored in a computer-readable medium in connection with the necessary hardware components, such as processor 1010, connection 1005, output device 1035, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the embodiments and examples provided herein, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

For clarity of explanation, in some instances the present technology may be presented as including individual functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual embodiments may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some embodiments the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods, algorithms, and/or operations described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more”are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:
Aspect 1. An apparatus for securing access to a wireless network, comprising: a memory system comprising instructions; and a processor system coupled to the memory system, wherein the processor system is configured to: record a set of unprotected messages exchanged between the apparatus and a wireless node, wherein the set of unprotected messages include at least one of: portions of system information messages broadcast by the wireless node, portions of a set of RA messages, or portions of a set of radio resource control (RRC) messages; receive a first hash value from the wireless node; generate a second hash value based on the recorded set of unprotected messages; and compare the second hash value to the first hash value to verify the set of unprotected messages.
Aspect 2. The apparatus of Aspect 1, wherein the processor system is further configured to transmit the second hash value to the wireless node to establish access stratum (AS) security between the wireless node and the apparatus.
Aspect 3. The apparatus of any of Aspects 1-2, wherein the processor system is further configured to: determine that the first hash value does not match the second hash value; receive a request for the set of unprotected messages indicating a verification failure for the set of unprotected messages; and transmit the set of unprotected messages to the wireless node using AS security.
Aspect 4. The apparatus of any of Aspects 1-3, wherein the set of RA messages includes at least a message2 message and a message4 message received by the apparatus and a RA preamble transmitted by the apparatus.
Aspect 5. The apparatus of Aspect 4, wherein the set of RA messages further includes a includes message3 message transmitted by the apparatus.
Aspect 6. The apparatus of any of Aspects 1-5, wherein the system information messages includes at least one of a master information block (MIB), synchronization signal block (SSB), or one or more system information blocks (SIBs).
Aspect 7. The apparatus of Aspect 6, wherein the portions of system information messages include an entirety of the MIB, SSB, or the one or more SIBs, except for information in MIB, SSB, or the one or more SIBs that are continuously changed over time.
Aspect 8. The apparatus of any of Aspects 1-7, wherein the processor system is further configured to receive an indication of the portions of system information messages broadcast by a wireless node and the portions of a set of RA messages for generating the second hash value to record.
Aspect 9. The apparatus of any of Aspects 1-8, wherein the portions of system information messages include at least one of a: physical random access channel configuration; available set of random access preambles; RA response window size; initial preamble power; power ramping factor; maximum number of preamble transmissions; or contention resolution timer.
Aspect 10. The apparatus of Aspect 9, wherein the portions of system information messages further includes at least one of a: location of a physical downlink control channel (PDCCH); or cell radio network temporary identifier (C-RNTI).
Aspect 11. The apparatus of any of Aspects 1-10, wherein the first hash value is received as a part of an access stratum (AS) security mode command message, and wherein the second hash value is transmitted as a part of an AS security mode complete message.
Aspect 12. The apparatus of any of Aspects 1-11, wherein the apparatus verifies the set of unprotected messages and the wireless node does not verify the set of unprotected messages.
Aspect 13. An apparatus for securing access to a wireless network, comprising: a memory system comprising instructions; and a processor system coupled to the memory system, wherein the processor system is configured to: record a set of unprotected messages exchanged between a wireless device and the apparatus for a random access (RA) procedure, wherein the set of unprotected messages include at least one of: portions of system information messages broadcast by the apparatus, portions of a set of RA messages, or portions of a set of radio resource control (RRC) messages; obtain a first hash value based on the recorded set of unprotected messages; receive a second hash value from a wireless device; compare the second hash value to the first hash value to verify the set of unprotected messages; and communicate with the wireless device using access stratum (AS) security.
Aspect 14. The apparatus of Aspect 13, wherein the processor system is further configured to output, for transmission to the wireless device, the first hash value.
Aspect 15. The apparatus of any of Aspects 13-14, wherein the processor system is further configured to: determine that the second hash value does not match the first hash value; and output, for transmission, a request for the set of unprotected messages indicating a verification failure for the set of unprotected messages.
Aspect 16. The apparatus of any of Aspects 13-15, wherein the set of RA messages includes at least a message2 message and a message4 message transmitted to the wireless device and a RA preamble received from the wireless device.
Aspect 17. The apparatus of Aspect 16, wherein the set of RA messages further includes a includes message3 message received from the wireless device.
Aspect 18. The apparatus of any of Aspects 13-17, wherein the system information messages includes at least one of a master information block (MIB), synchronization signal block (SSB), or one or more system information blocks (SIBs).
Aspect 19. The apparatus of Aspect 18, wherein the portions of system information messages include an entirety of the MIB, SSB, or the one or more SIBs, except for information in MIB, SSB, or the one or more SIBs that are continuously changed over time.

Aspect 20. The apparatus of any of Aspects 18-19, wherein the processor system is further configured to output, for transmission to the wireless device, an indication of the portions of system information messages broadcast and the portions of a set of RA messages for generating the second hash value.
Aspect 21. The apparatus of any of Aspects 13-20, wherein the portions of system information messages include at least one of a: physical random access channel configuration; available set of random access preambles; RA response window size; initial preamble power; power ramping factor; maximum number of preamble transmissions; or contention resolution timer.
Aspect 22. The apparatus of Aspect 21, wherein the portions of system information messages further includes at least one of a: location of a physical downlink control channel (PDCCH); or cell radio network temporary identifier (C-RNTI).
Aspect 23. The apparatus of any of Aspects 13-22, wherein the first hash value is output for transmission as a part of an access stratum (AS) security mode command message, and wherein the second hash value is received as a part of an AS security mode complete message.
Aspect 24. The apparatus of any of Aspects 13-23, wherein the apparatus verifies the set of unprotected messages and the wireless device does not verify the set of unprotected messages.
Aspect 25. The apparatus of any of Aspects 13-24, wherein the processor system is further configured to: transmit the set of unprotected messages to an RRC service; and receive the first hash value from the RRC service.
Aspect 26. A method for securing access to a wireless network, comprising: recording a set of unprotected messages exchanged between a wireless device and a wireless node, wherein the set of unprotected messages include at least one of: portions of system information messages broadcast by the wireless node, portions of a set of RA messages, or portions of a set of radio resource control (RRC) messages; receiving a first hash value from the wireless node; generating a second hash value based on the recorded set of unprotected messages; and comparing the second hash value to the first hash value to verify the set of unprotected messages.
Aspect 27. The method of Aspect 26, further comprising transmitting the second hash value to the wireless node to establish access stratum (AS) security between the wireless node and the wireless device.
Aspect 28. The method of any of Aspects 26-27, further comprising: determining that the first hash value does not match the second hash value; receiving a request for the set of unprotected messages indicating a verification failure for the set of unprotected messages; and transmitting the set of unprotected messages to the wireless node using AS security.
Aspect 29. The method of any of Aspects 26-28, wherein the set of RA messages includes at least a message2 message and a message4 message received by the wireless device and a RA preamble transmitted by the wireless device.
Aspect 30. The method of Aspect 29, wherein the set of RA messages further includes a includes message3 message transmitted by the wireless device.
Aspect 31. The method of any of Aspects 26-30, wherein the system information messages includes at least one of a master information block (MIB), synchronization signal block (SSB), or one or more system information blocks (SIBs).
Aspect 32. The method of Aspect 31, wherein the portions of system information messages include an entirety of the MIB, SSB, or the one or more SIBs, except for information in MIB, SSB, or the one or more SIBs that are continuously changed over time.
Aspect 33. The method of any of Aspects 26-32, further comprising receiving an indication of the portions of system information messages broadcast by a wireless node and the portions of a set of RA messages for generating the second hash value to record.
Aspect 34. The method of any of Aspects 26-33, wherein the portions of system information messages include at least one of a: physical random access channel configuration; available set of random access preambles; RA response window size; initial preamble power; power ramping factor; maximum number of preamble transmissions; or contention resolution timer.
Aspect 35. The method of Aspect 34, wherein the portions of system information messages further includes at least one of a: location of a physical downlink control channel (PDCCH); or cell radio network temporary identifier (C-RNTI).
Aspect 36. The method of any of Aspects 26-35, wherein the first hash value is received as a part of an access stratum (AS) security mode command message, and wherein the second hash value is transmitted as a part of an AS security mode complete message.
Aspect 37. The method of any of Aspects 26-36, wherein the wireless device verifies the set of unprotected messages and the wireless node does not verify the set of unprotected messages.
Aspect 38. A method for securing access to a wireless network, comprising: recording a set of unprotected messages exchanged between a wireless device and a wireless node for a random access (RA) procedure, wherein the set of unprotected messages include at least one of: portions of system information messages broadcast by the wireless node, portions of a set of RA messages, or portions of a set of radio resource control (RRC) messages; obtaining a first hash value based on the recorded set of unprotected messages; receiving a second hash value from a wireless device; comparing the second hash value to the first hash value to verify the set of unprotected messages; and communicating with the wireless device using access stratum (AS) security.
Aspect 39. The method of Aspect 38, further comprising outputting, for transmission to the wireless device, the first hash value.
Aspect 40. The method of any of Aspects 38-39, further comprising: determining that the second hash value does not match the first hash value; and outputting, for transmission, a request for the set of unprotected messages indicating a verification failure for the set of unprotected messages.
Aspect 41. The method of any of Aspects 38-40, wherein the set of RA messages includes at least a message2 message and a message4 message transmitted to the wireless device and a RA preamble received from the wireless device.
Aspect 42. The method of Aspect 41, wherein the set of RA messages further includes a includes message3 message received from the wireless device.
Aspect 43. The method of any of Aspects 38-42, wherein the system information messages includes at least one of a master information block (MIB), synchronization signal block (SSB), or one or more system information blocks (SIBs).
Aspect 44. The method of Aspect 43, wherein the portions of system information messages include an entirety of the MIB, SSB, or the one or more SIBs, except for information in MIB, SSB, or the one or more SIBs that are continuously changed over time.
Aspect 45. The method of any of Aspects 43-44, further comprising outputting, for transmission to the wireless device, an indication of the portions of system information messages broadcast and the portions of a set of RA messages for generating the second hash value.
Aspect 46. The method of any of Aspects 38-45, wherein the portions of system information messages include at least one of a: physical random access channel configuration; available set of random access preambles; RA response window size; initial preamble power; power ramping factor; maximum number of preamble transmissions; or contention resolution timer.
Aspect 47. The method of Aspect 46, wherein the portions of system information messages further includes at least one of a: location of a physical downlink control channel (PDCCH); or cell radio network temporary identifier (C-RNTI).
Aspect 48. The method of any of Aspects 38-47, wherein the first hash value is output for transmission as a part of an access stratum (AS) security mode command message, and wherein the second hash value is received as a part of an AS security mode complete message.
Aspect 49. The method of any of Aspects 38-48, wherein the wireless node verifies the set of unprotected messages and the wireless device does not verify the set of unprotected messages
Aspect 50. The method of any of Aspects 38-49, further comprising: transmitting the set of unprotected messages to an RRC service; and receiving the first hash value from the RRC service.
Aspect 51. A non-transitory computer-readable medium having stored thereon instructions that, when executed by at least one processor to perform operations according to any of Aspects 26-37.
Aspect 52. A non-transitory computer-readable medium having stored thereon instructions that, when executed by at least one processor to perform operations according to any of Aspects 38-50.
Aspect 53. An apparatus for securing access to a wireless network comprising one or more means for performing operations according to any of Aspects 26-37
Aspect 54. An apparatus for securing access to a wireless network comprising one or more means for performing operations according to any of Aspects 38-50.

What is claimed is:

1. An apparatus for securing access to a wireless network, comprising:
a memory system comprising instructions; and
a processor system coupled to the memory system, wherein the processor system is configured to:
record a set of unprotected messages exchanged between the apparatus and a wireless node, wherein the set of unprotected messages include at least one of: portions of system information messages broadcast by the wireless node, portions of a set of RA messages, or portions of a set of radio resource control (RRC) messages;
receive a first hash value from the wireless node;
generate a second hash value based on the recorded set of unprotected messages; and
compare the second hash value to the first hash value to verify the set of unprotected messages.

2. The apparatus of claim 1, wherein the processor system is further configured to transmit the second hash value to the wireless node to establish access stratum (AS) security between the wireless node and the apparatus.

3. The apparatus of claim 2, wherein the first hash value is received as a part of an access stratum (AS) security mode command message, and wherein the second hash value is transmitted as a part of an AS security mode complete message.

4. The apparatus of claim 1, wherein the processor system is further configured to:
determine that the first hash value does not match the second hash value;
receive a request for the set of unprotected messages indicating a verification failure for the set of unprotected messages; and
transmit the set of unprotected messages to the wireless node using AS security.

5. The apparatus of claim 1, wherein the set of RA messages includes at least a message2 message and a message4 message received by the apparatus and a RA preamble transmitted by the apparatus.

6. The apparatus of claim 5, wherein the set of RA messages further includes a includes message3 message transmitted by the apparatus.

7. The apparatus of claim 1, wherein the system information messages includes at least one of a master information block (MIB), synchronization signal block (SSB), or one or more system information blocks (SIBs).

8. The apparatus of claim 7, wherein the portions of system information messages include an entirety of the MIB, SSB, or the one or more SIBs, except for information in MIB, SSB, or the one or more SIBs that are continuously changed over time.

9. The apparatus of claim 1, wherein the processor system is further configured to receive an indication of the portions of system information messages broadcast by a wireless node and the portions of a set of RA messages for generating the second hash value to record.

10. The apparatus of claim 1, wherein the portions of system information messages include at least one of a:
physical random access channel configuration;
available set of random access preambles;
RA response window size;
initial preamble power;
power ramping factor;
maximum number of preamble transmissions; or
contention resolution timer.

11. The apparatus of claim 10, wherein the portions of system information messages further include at least one of a:
location of a physical downlink control channel (PDCCH); or
cell radio network temporary identifier (C-RNTI).

12. The apparatus of claim 1, wherein the apparatus verifies the set of unprotected messages and the wireless node does not verify the set of unprotected messages.

13. A method for securing access to a wireless network, comprising:
recording a set of unprotected messages exchanged between a wireless device and a wireless node, wherein the set of unprotected messages include at least one of: portions of system information messages broadcast by the wireless node, portions of a set of RA messages, or portions of a set of radio resource control (RRC) messages;
receiving a first hash value from the wireless node;
generating a second hash value based on the recorded set of unprotected messages; and
comparing the second hash value to the first hash value to verify the set of unprotected messages.

14. The method of claim 13, further comprising transmitting the second hash value to the wireless node to establish access stratum (AS) security between the wireless node and the wireless device.

15. The method of claim 13, further comprising:
determining that the first hash value does not match the second hash value;
receiving a request for the set of unprotected messages indicating a verification failure for the set of unprotected messages; and
transmitting the set of unprotected messages to the wireless node using AS security.

16. The method of claim 13, wherein the set of RA messages includes at least a message2 message and a message4 message received by the wireless device and a RA preamble transmitted by the wireless device.

17. The method of claim 16, wherein the set of RA messages further includes a includes message3 message transmitted by the wireless device.

18. The method of claim 13, wherein the system information messages includes at least one of a master information block (MIB), synchronization signal block (SSB), or one or more system information blocks (SIBs).

19. The method of claim 18, wherein the portions of system information messages include an entirety of the MIB, SSB, or the one or more SIBs, except for information in MIB, SSB, or the one or more SIBs that are continuously changed over time.

20. The method of claim 13, further comprising receiving an indication of the portions of system information messages broadcast by a wireless node and the portions of a set of RA messages for generating the second hash value to record.
